(19) United States
(12) Patent Application Publication
(10) Pub. No.: US 2025/0312986 A1
(43) Pub. Date: Oct. 9, 2025

(54) LAMINATED, NONWOVEN FABRICS INCLUDING 3D EMBOSSED PATTERNS AND FOOD SERVICE WIPES FORMED FROM SAME

(71) Applicant: KCooper Brands, Inc., Aurora, CO (US)

(72) Inventor: Greg Roth, Tinley Park, IL (US)

(21) Appl. No.: 19/174,136

(22) Filed: Apr. 9, 2025

Related U.S. Application Data
(60) Provisional application No. 63/631,804, filed on Apr. 9, 2024.

(51) Int. Cl. B32B 5/02; B32B 5/26; B32B 27/32

(52) U.S. Cl. CPC B32B 5/022; B32B 5/26; B32B 27/32; B32B 2250/03; B32B 2307/718; B32B 2307/7376; B32B 2432/00

(57) ABSTRACT

Laminated, nonwoven fabrics and food service wipes formed from the nonwoven fabrics are disclosed. The laminated, nonwoven fabrics forming the food service wipes include an inner layer formed from a spunbond material, and a first outer layer disposed over the inner layer. The first outer layer is formed from a meltblown material. Additionally, the laminated, nonwoven fabrics forming the food service wipes include a second outer layer disposed over the inner layer, opposite the first outer layer. Moreover, the laminated, nonwoven fabrics include a three-dimensional (3D) embossed pattern.

### CROSS-REFERENCE TO RELATED APPLICATIONS

The present application claims priority or the benefit to U.S. provisional application No. 63/631,804, filed Apr. 9, 2024, and entitled “3D Embossed Food Service Wiper,” the entire disclosure of which is hereby incorporated by reference herein.

### TECHNICAL FIELD

The disclosure relates generally to nonwoven fabrics, and more particularly, to laminated, nonwoven fabrics including three-dimensional (3D) embossed patterns and food service wipes formed from laminated, nonwoven fabrics.

### BACKGROUND

Nonwoven fabrics have been widely used in various industries due to their versatility, cost-effectiveness, and ease of production. For example, nonwoven fabrics are used in disposable and non-disposable products including, but not limited to, medical products, garments, cleaning supplies, and personal care items. Conventional nonwoven fabrics include materials such as polyolefins, polyesters, poly(lactic acid)s, rayon or cotton. A common approach for forming nonwoven fabrics involves layering a spunbond material with a meltblown material to create a composite fabric that offers both strength and absorption capabilities.

However, each of these materials used in creating conventional nonwoven materials or fabrics create difficulties and/or have negative effects within the industries and purposes in which the nonwoven materials are developed. For example, polyester-blend (e.g., viscose) or cotton-based cleaning towels use for cleaning and/or disinfecting food contact surfaces are negatively charged and/or carry a negative electrostatic charge. As a result, when these polyester or cotton-based cleaning towels are left in a disinfecting solution that is negatively charged, the polyester or cotton-based cleaning towels attract and/or absorb a portion of the chemicals within the disinfecting solution. This in turn results in the solution being less or completely ineffective in disinfecting and/or destroying harmful bacteria often associated with the preparation of raw food.

Additionally, and in order to achieve desired properties relating to tensile strength, elongation, titration, and/or absorption, conventional nonwoven fabrics used in disposable products (e.g., cleaning products, medial products, personal care items) require thicker and/or heavier materials to meet demands. For example, some disposable wipes used in the food service industry for sterilizing surfaces are often made from nonwoven fabrics having a fabric weight equal to or greater than sixty (60) grams per square meter (GSM). These conventional, disposable wipes include such heavy fabric to meet tensile strength and/or elongation requirements in order to withstand the desire use. However, modern trends aim to reduce waste and reduce the amount of disposable products dumped in landfills each year.

Accordingly, it would be desirable to create a nonwoven fabric that is capable of meeting all mechanical and/or tactile requirements of use, while also reducing the amount or weight of the nonwoven material used, without reducing the tactile requirements.

### BRIEF DESCRIPTION

A first aspect of the disclosure provides a laminated, nonwoven fabric including an inner layer formed from a spunbond material, and a first outer layer disposed over the inner layer. The first outer layer is formed from a meltblown material. The laminated, nonwoven fabric also includes a second outer layer disposed over the inner layer, opposite the first outer layer. Additionally, at least one of the first outer layer or the second outer layer include a three-dimensional (3D) embossed pattern.

A second aspect of the disclosure provides a food service wipe including a laminated, nonwoven fabric. The laminated, nonwoven fabric includes an inner layer formed from a spunbond material, and a first outer layer disposed over the inner layer. The first outer layer is formed from a meltblown material. Additionally, the laminated, nonwoven fabric forming the food service wipe includes a second outer layer disposed over the inner layer, opposite the first outer layer, wherein the laminated, nonwoven fabric includes a three-dimensional (3D) embossed pattern.

A third aspect of the disclosure provides a wiper including a polypropylene material, and a three-dimensional pattern embossed on a surface of the polypropylene material.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of a wipe formed from a laminated, nonwoven fabric, according to embodiments.

FIG. 2 shows a cross-sectional front view of the wipe of FIG. 1 taken along line CS-CS, according to embodiments.

FIG. 3 shows a cross-sectional front view of a wipe formed from a laminated, nonwoven fabric, according to additional embodiments.

FIG. 4 shows a cross-sectional front view of a wipe formed from a laminated, nonwoven fabric, according to another embodiment.

FIG. 5 shows a cross-sectional front view of a wipe formed from a laminated, nonwoven fabric, according to further embodiment.

FIG. 6 shows a top view of a wipe formed from a laminated, nonwoven fabric including a three-dimensional (3D) embossed pattern, according to embodiments.

FIG. 7 shows a top view of a wipe formed from a laminated, nonwoven fabric including a 3D embossed pattern, according to additional embodiments.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure it will become necessary to select certain terminology when referring to and describing relevant components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As discussed herein, the disclosure relates generally to nonwoven fabrics, and more particularly, to laminated, nonwoven fabrics including three-dimensional (3D) embossed patterns and food service wipes formed from laminated, nonwoven fabrics.

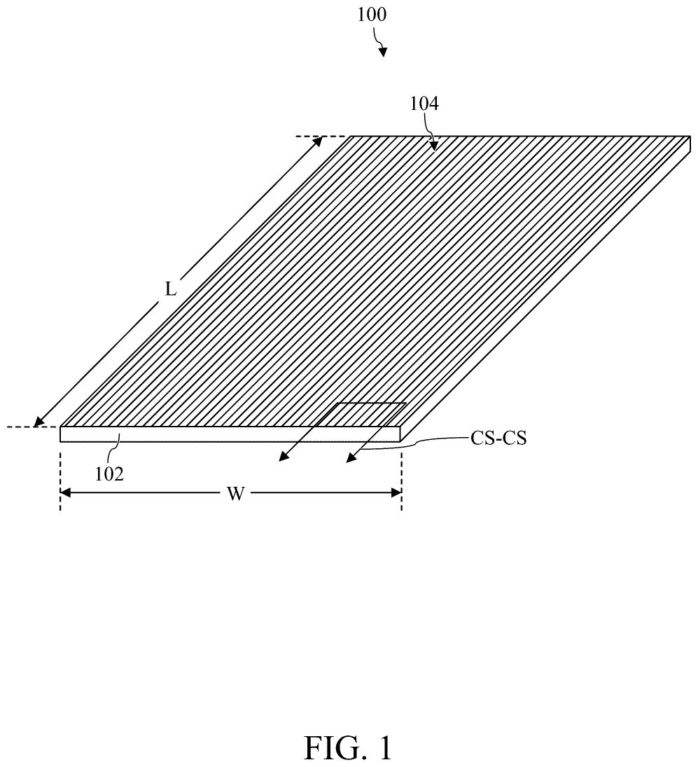

These and other embodiments are discussed below with reference to FIGS. 1-7. However, those skilled in the art will readily appreciate that the detailed description given herein with respect to these Figures is for explanatory purposes only and should not be construed as limiting.

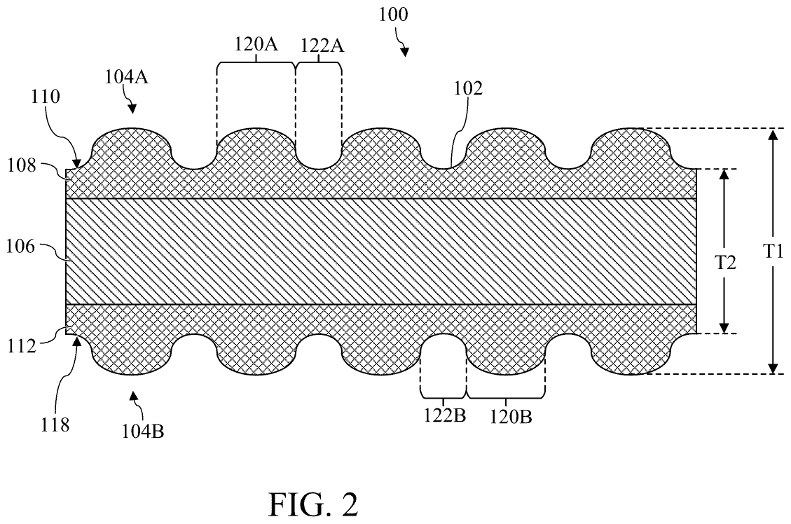

FIGS. 1 and 2 show various views of a wipe 100 formed from a laminated, nonwoven fabric 102. More specifically, FIG. 1 shows a perspective view of wipe 100 and FIG. 2 shows a cross-sectional front view of wipe 100 taken along line CS-CS in FIG. 1. Wipe 100 shown in FIGS. 1 and 2 can be used, for example, in the food service industry and/or for cleaning food-contact surfaces including, but not limited to, tables in restaurants, countertops, food preparation stations, food storage areas, and the like. In non-limiting examples, wipe 100 is combined with and/or utilized with a sanitizer solution to clean food-contact surfaces, remove/absorb debris (e.g., food remnants, scraps, dirt, etc.), and pick-up particles from the surfaces to be cleaned. Additionally, or alternatively, wipe 100 can be used for general or other specialty cleaning purposes including, but not limited to, household cleaning, hospital and sterile environment cleaning, manufacturing and industrial cleaning, and the like.

As used herein the terms “nonwoven,” “nonwoven web,” and “nonwoven fabric” refer to a structure or a web of material which has been formed without use of weaving or knitting processes to produce a structure of individual fibers or threads which are intermeshed, but not in an identifiable, repeating manner. Nonwoven webs and/or nonwoven fabrics may be formed by any suitable processes including, but not limited to, meltblown processes, spunbond processes, staple fiber carding processes, and the like. Moreover, and as used herein, the terms “laminate” and “laminated” refer to a structure that is formed from multiple layers and/or materials that are bonded or joined together. In exemplary embodiments, multiple layers are bonded or joined together after undergoing, for example, a lamination process in which pressure and/or heat is applied to the stacked layers of material to form the laminated, nonwoven fabric. Additionally, or alternatively, an adhesive may be applied between each layer of the material to aid in the bonding or lamination of the multiple materials.

Wipe 100 formed from laminated, nonwoven fabric 102 includes predetermined dimensions. For example, wipe 100 includes a predetermined length (L), and a predetermined width (W). In exemplary embodiments, the predetermined length (L) of wipe 100 can be between approximately 12 inches and approximately 24 inches, while the predetermined width (W) is between approximately 6 inches and approximately 12 includes. In one example, the wipe 100 includes a length (L) of approximately 18 inches, and a width of approximately 10 inches. It is to be understood that a size of wipe 100 is not limited to the exemplary ranges for the length (L) and width (W) provided, but rather wipe 100 can include substantially any size (e.g., width (W), length (L)) based on the intended use.

Additionally as shown in FIGS. 1 and 2, and as discussed herein, wipe 100 includes a three-dimensional (3D) embossed pattern 104 formed thereon and/or therein. That is, and as discussed herein with respect to FIG. 2, 3D embossed pattern 104 is formed in and/or on at least one surface and/or layer of nonwoven fabric 102 forming wipe 100. 3D embossed pattern 104 included in wipe 100 increases a thickness “feel” of the wipes, and also improves wipe's 100 ability to pick-up particles while in use (e.g., cleaning surfaces), for example.

As discussed herein, wipe 100 is formed from a laminated, nonwoven fabric 102. In exemplary embodiments, nonwoven fabric 102 is formed from a plurality of layers of material that are joined together, bonded, and/or laminated to one another to form a single, cohesive fabric. Additionally, each layer of material forming wipe 100 is formed from a nonwoven fabric, as discussed herein. In the non-limiting example shown in FIG. 2, laminated, nonwoven fabric 102 includes an inner layer 106 formed from a spunbond material. Spunbond material forming inner layer 106 of nonwoven fabric 102 is formed from a thermoplastic polymer material. More specifically, spunbond material forming inner layer 106 is formed as and/or from polypropylene (PP). Forming inner layer 106 of nonwoven fabric 102 as a spunbond material including polypropylene (PP) provides increased tensile strength and/or durability for wipe 100, as discussed herein. Additionally in exemplary embodiments, inner layer 106 is non-polar and/or does not have a positive or negative charge. As discussed herein, the non-polar inner layer 106, and/or the non-polar characteristics of other portions of nonwoven fabric 102, substantially reduces or eliminates the chemical reaction and/or absorption of sanitizer solutions typically used in associated with wipe 100 for the purposes of cleaning surfaces in the food industry.

As used herein, the term “spunbond” refers to a process involving extruding a molten thermoplastic material (e.g., polypropylene (PP)) as filaments from a plurality of fine, usually circular, capillaries of a spinneret, with the filaments then being attenuated and drawn mechanically or pneumatically. The filaments are deposited on a collecting surface to form a web of randomly arranged substantially continuous filaments which can thereafter be bonded together to form a coherent nonwoven fabric. In general, spunbond processes include, but are not limited to, extruding the filaments from a spinneret, quenching the filaments with a flow of air to hasten the solidification of the molten filaments, attenuating the filaments by applying a draw tension, either by pneumatically entraining the filaments in an air stream or mechanically by wrapping them around mechanical draw rolls, depositing the drawn filaments onto a foraminous collection surface to form a web, and bonding the web of loose filaments into a nonwoven fabric. The bonding can be any thermal or chemical bonding treatment, with thermal point bonding being typical.

Nonwoven fabric 102 forming wipe 100 also includes a first outer layer 108 disposed over and/or bonded to inner layer 106. As discussed herein, first outer layer 108 is bonded to and/or laminated with inner layer 106 of nonwoven fabric 102 using any suitable technique and/or process (e.g., bonding process, lamination process, etc.). In the non-limiting example shown in FIG. 2, first outer layer 108 includes a first outer surface 110 that is exposed in wipe 100. Additionally, first outer layer 108 is formed from a meltblown material. Meltblown material forming first outer layer 108 of nonwoven fabric 102 is formed from a thermoplastic polymer material. More specifically, and similar to inner layer 106, meltblown material forming first outer layer 108 is formed as and/or from polypropylene (PP).

As shown in FIG. 2, laminated, nonwoven fabric 102 forming wipe 100 also includes a second outer layer 112 disposed over and/or bonded to inner layer 106, opposite first outer layer 108. Similar to first outer layer 108, second outer layer 112 is bonded to and/or laminated with inner layer 106 of nonwoven fabric 102 using any suitable technique and/or process (e.g., bonding process, lamination process, etc.). Second outer layer 112 includes a second outer surface 118 that is exposed in wipe 100. Second outer surface 118 is formed opposite first outer surface 110 of first outer layer 108 in wipe 100 formed from nonwoven fabric 102. In exemplary embodiments, and also similar to first outer layer 108, second outer layer 112 is formed from a meltblown material. Meltblown material forming second outer layer 112 of nonwoven fabric 102 is formed from a thermoplastic polymer material. More specifically, meltblown material forming second outer layer 112 is formed as and/or from polypropylene (PP).

Forming first outer layer 108 and second outer layer 112 of nonwoven fabric 102 from a meltblown material including polypropylene (PP) provides increased and/or improved absorption properties for wipe 100, as discussed herein. Additionally in exemplary embodiments, first outer layer 108 and second outer layer 112 of nonwoven fabric 102 are non-polar. As discussed herein, non-polar first outer layer 108 and second outer layer 112 substantially reduce or eliminate the chemical reaction and/or absorption of sanitizer solutions typically used in associated with wipe 100 for the purposes of cleaning surfaces in the food industry.

As used herein, the term “meltblown” refers to a process in which fibers are formed by extruding a molten thermoplastic material through a plurality of fine, usually circular, die capillaries into a high velocity gas (e.g. air) stream which attenuates the molten thermoplastic material and forms fibers, which can be to microfiber diameter. Thereafter, the meltblown fibers are carried by the gas stream and are deposited on a collecting surface to form a web of random meltblown fibers.

In the exemplary embodiment shown in FIG. 2, nonwoven fabric 102 forming wipe 100 includes a meltblown-spunbond-meltblown (MSM) configuration. That is, and as discussed herein, inner layer 106 is formed from a spunbond material, while each outer layer 108, 112 surrounding and/or disposed on opposing sides of inner layer 106 are formed from meltblown material. Including an internal or inner material formed from spunbond material, while having two outer materials formed from meltblown material facilitates added benefits to nonwoven fabric 102 and/or wipe 100 over conventional configurations (e.g., spunbond-meltblown-spunbond (SMS)).

Furthermore, and as discussed herein, wipe 100 formed from nonwoven fabric 102 includes 3D embossed pattern 104. In the non-limiting example shown in FIG. 2, 3D embossed pattern 104A, 104B is included and/or formed in first outer layer 108 and second outer layer 112 of nonwoven fabric 102, respectively. More specifically, first outer surface 110 of first outer layer 108 includes 3D embossed pattern 104A formed therein and/or thereon, and second outer surface 118 of second outer layer 112 include 3D embossed pattern 104B formed therein and/or thereon. As a result of forming 3D embossed patterns 104A, 104B in first outer layer 108 and second outer layer 112, the respective outer surfaces 110, 118 are non-planar and/or non-uniform. In the exemplary embodiment shown in FIG. 2, and with continued reference to FIG. 1, 3D embossed pattern 104A, 104B formed within first outer layer 108 and second outer layer 112, respectively, includes a substantially linear embossment or imprint pattern that includes a plurality of ridges or bumps 120A, 120B which extend in a length-wise direction of wipe 100 (e.g., in-and-out of page in FIG. 2). Separating each bump 120A, 120B of 3D embossed pattern 104A, 104B is a valley or depression 122A, 122B, which also extends length-wise across the entirety of wipe 100 (see, FIG. 1). Additionally, 3D embossed pattern 104A, 104B is formed in and/or on nonwoven fabric 102 using any suitable processes and/or technique including, but not limited to, embossing processes, imprinting processes, calendaring processes, and the like.

Nonwoven fabric 102 forming wipe 100, as shown in FIG. 2, includes a predetermined amount and/or number of embossed impressions within the fabric based on size. For example, 3D embossed pattern 104A, 104B of nonwoven fabric 102 includes between approximately fifteen (15) impressions per square inch (in.²) and approximately twenty-five (25) impressions/in.². More specifically, 3D embossed pattern 104A, 104B of nonwoven fabric 102 forming wipe 100 includes approximately twenty (20) impressions/in.².

Additionally, the inclusion of 3D embossed pattern 104A, 104B in nonwoven fabric 102 results in wipe 100 including two distinct thickness (T1, T2). For example, and as shown in FIG. 2, a first predetermined thickness (T1) of wipe 100, measured between two aligned bumps 120A, 120B formed in outer layers 108, 112, is between approximately 15 mils (e.g., thousands of an inch) and approximately 45 mils. Furthermore in the exemplary embodiment, a second predetermined thickness (T2) of wipe 100, measured between two aligned depressions 122A, 122B formed in outer layers 108, 112, is between 20 mils and approximately 40 mils. In another non-limiting example, the first predetermined thickness (T1) of wipe 100 is between approximately 10 mils and approximately 80 mils, while the second predetermined thickness (T2) is between approximately 5 mills and approximately 70 mils.

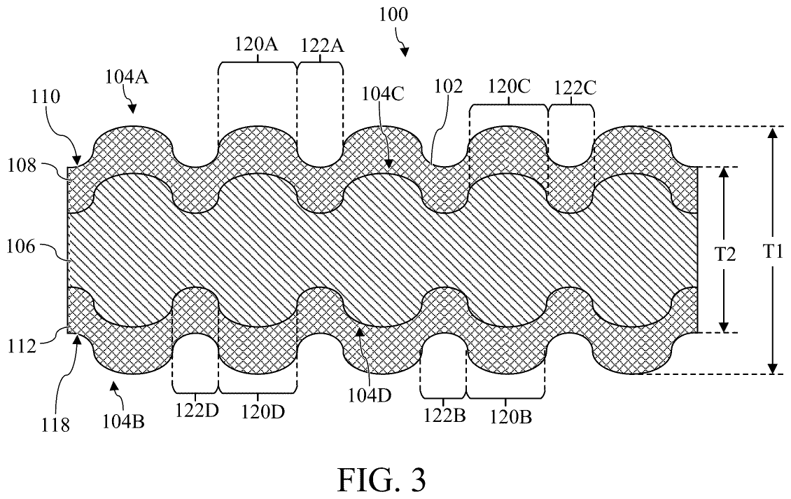

In the non-limiting example shown in FIG. 2, 3D embossed pattern 104A, 104B is only formed in respective outer layers 108, 112, and does not extend into, and/or is formed in inner layer 106. That is and based on processes used to form 3D embossed pattern 104, respective bumps 120A, 120B and depressions 122A, 122B are only made in outer layers 108, 112 and are not made or formed in inner layer 106 of nonwoven fabric 102. In other non-limiting examples (see, FIG. 3), 3D embossed pattern 104A, 104B is also formed in and/or extends at least partially through and/or is formed within inner layer 106.

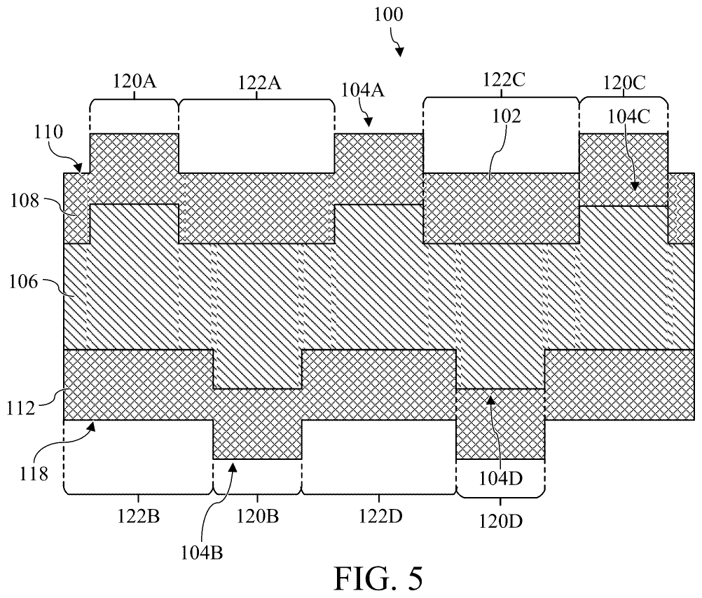

Additionally as shown in FIG. 2, each bump 120A and depression 122A forming 3D embossed pattern 104A in first outer layer 108 is substantially aligned with a distinct bump 120B and depression 122B of 3D embossed pattern 104B formed in second outer layer 112. In other non-limiting examples (see, FIG. 5), embossed features (e.g., bumps 120, depressions 122) forming 3D embossed pattern 104A in first outer layer 108 may be offset from and/or staggered from embossed features forming 3D embossed pattern 104B in second outer layer 112.

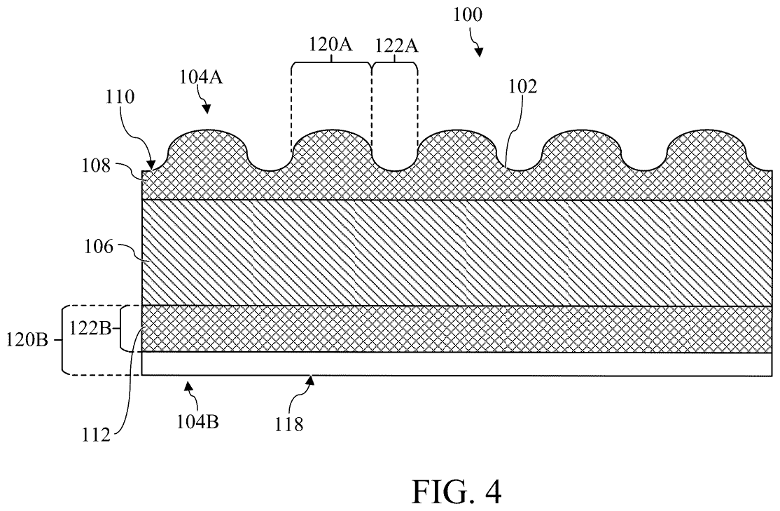

Although discussed and shown herein as bumps 120 and depressions 122, it is understood that 3D embossed pattern 104 can include any suitable shape(s) and/or configuration that result in first outer surface 110 and/or second outer surface 118 being non-planar (see, FIGS. 5-7). Moreover, it is to be understood that 3D embossed patterns 104A, 104B can be identical to one another, or alternatively each 3D embossed pattern 104A, 104B formed in respective outer layers 108, 112 can be distinct from one another (see, FIG. 4).

Forming embossed patterns 104A, 104B in nonwoven fabric 102 improves the structure, as well as provided increased benefits of use for wipe 100. For example, the inclusion and/or formation of embossed patterns 104A, 104B within nonwoven fabric 102 improves particle pick-up capabilities (e.g., debris, food particles, etc.) for wipe 100 equal to or greater than approximately double the measured particle pick-up capabilities above conventional nonwoven fabrics having no embossed patterns formed therein. That is, and as a result of the increase surface area of nonwoven fabric 102 including 3D embossed patterns 104A, 104B, wipe 100 is capable of increased particle pick-up when used in association with cleaning.

Additionally, the formation of 3D embossed patterns 104A, 104B within nonwoven fabric 102 facilitates wipe 100 having, appearing to have, and/or “feeling” as though it has larger, desired thickness than a comparable, non-embossed material. In non-limiting examples, nonwoven fabric 102 includes a fabric weight between approximately thirty (30) grams per square meter (GSM) and approximately sixty (60) GSM. However, the inclusion of 3D embossed patterns 104A, 104B within nonwoven fabric 102 forming wipe 100, and the resulting increased surface area and varied thickness (T1, T2), results in wipe 100 tactilely feeling thicker and/or having a heavier fabric weight than the actual fabric weight of nonwoven fabric 102. For example, wipe 100 formed from nonwoven fabric 102 having a fabric weight equal to thirty-four (34) GSM tactilely feels like a wipe 100 formed from a fabric having a fabric weight equal to approximately sixty (60) GSM when wet and/or after absorbing a liquid (e.g., water, cleaning solution). Wipe 100 tactilely feels heavier when wet and/or saturated as a result of 3D embossed pattern 104A, 104B increasing the surface area and/or increasing surface tension within wipe 100. As such, the inclusion of 3D embossed pattern 104A, 104B within nonwoven fabric 102 nearly doubles the feel of the weight and/or thickness of wipe 100 (e.g., 60 GSM), while still forming wipe 100 from a lower fabric weight material (e.g., 34 GSM). Forming wipe 100 from nonwoven fabric 102 having lower fabric weight (e.g., 34 GSM) also results in less weight and/or less material being used to form wipes 100. This in turn results in less material being discarded after use (e.g., less space in landfills or recycling facilities), and/or can reduce the cost of manufacturing wipes 100. For example, wipe 100 formed from nonwoven fabric 102 having lower fabric weight can reduce the cost compared to conventional wipes by up to 30%.

As discussed herein, laminated, nonwoven fabric 102 forming wipe 100 includes a meltblown-spunbond-meltblown (MSM) configuration, where inner layer 106 is formed from a spunbond polypropylene (PP), and outer layers 108, 112 are each formed from a meltblown polypropylene (PP). In addition to the increased surface area created by forming nonwoven fabric 102 to include 3D embossed pattern 104A, 104B, the material selection for nonwoven fabric 102 also increase the absorption capabilities of wipe 100. For example, forming first outer layer 108 and second outer layer 112 from a meltblown polypropylene (PP) including 3D embossed pattern 104 improves absorption capabilities for wipe 100 at least by approximately 500% above conventional nonwoven fabrics having no embossed patterns formed therein and/or conventional nonwoven fabrics formed from distinct materials (e.g., polyester, polyethylene). Additionally, or alternatively, forming first outer layer 108 and second outer layer 112 from a meltblown polypropylene (PP) including 3D embossed pattern 104 also improves absorption capabilities for wipe 100 having a lower fabric weight (e.g., GSM) than a heavier fabric weight for conventional nonwoven fabrics. For example, wipe 100 having a fabric weight of approximately 34 GSM is capable of absorbing substantially the same amount of liquid as a conventional, nonwoven fabric having a fabric weight of approximately 60 GSM. Moreover, forming nonwoven fabric 102 to include a spunbond polypropylene (PP) inner layer 106, and meltblown polypropylene (PP) outer layers 108, 112 also improves titration equal or greater than 80%, when compared to conventional nonwoven fabrics.

The meltblown-spunbond-meltblown (MSM) configuration of nonwoven fabric 102 also improves the tensile strength and elongation of wipe 100. More specifically, forming nonwoven fabric 102 to include a spunbond polypropylene (PP) inner layer 106, and meltblown polypropylene (PP) outer layers 108, 112 increases the machine direction (MD) and cross-machine direction (CD) tensile strengths for wipe 100. In exemplary embodiments, a machine direction (MD) tensile strength for nonwoven fabric 102 forming wipe 100 is between approximately thirty (30) grams force per inch per grams per square meter (gf/in/GSM) and approximately eighty (80) gf/in/GSM, while a cross-machine direction (CD) tensile strength for nonwoven fabric 102 between approximately ten (10) gf/in/GSM and approximately forty (40) gf/in/GSM. Moreover, a machine direction (MD) elongation for nonwoven fabric 102 forming wipe 100 is between approximately 15% and approximately 30%, and a cross-machine direction (CD) elongation for nonwoven fabric 102 is between approximately 30% and approximately 60%.

As used herein, the term “machine direction” or “MD” refers to the direction of travel of the nonwoven fabric during manufacturing. As used herein, the term “cross-machine direction” or “CD” refers to a direction that is perpendicular to the machine direction and extends laterally across the width of the nonwoven fabric.

FIGS. 3-5 show additionally non-limiting examples of wipe 100 formed from laminated, nonwoven fabric 102. Specifically, FIGS. 3-5 show cross-sectional front views of additional exemplary embodiments of nonwoven fabric 102 forming wipes 100, as similarly discussed herein. It is understood that similarly numbered and/or named components may function in a substantially similar fashion. Redundant explanation of these components has been omitted for clarity.

FIG. 3 shows a cross-sectional front view of a non-limiting example of wipe 100 taken along line CS-CS in FIG. 1. In the non-limiting example, 3D embossed pattern 104 extends into and/or are formed within inner layer 106. More specifically, 3D embossed pattern 104 includes 3D embossed pattern 104A formed in first outer layer 108, 3D embossed pattern 104B formed in second outer layer 112, and 3D embossed patterns 104C, 104D formed in inner layer 106. As shown in FIG. 3, and as a result of processes forming 3D embossed patterns 104A-104D within nonwoven fabric 102, embossed pattern 104C of inner layer 106 is substantially similar to and/or corresponds to embossed pattern 104A formed in first outer layer 108. More specifically, 3D embossed pattern 104C includes bumps 120C formed therein and/or thereon, and depressions 122C separating each bump 120C. As shown in FIG. 3, each bump 120C included in embossed pattern 104C is substantially aligned with a corresponding bump 120A of 3D embossed pattern 104A formed in first outer layer 108. Additionally in the non-limiting example, each bump 120C included in embossed pattern 104C is substantially aligned with a corresponding bump 120B of 3D embossed pattern 104B formed in second outer layer 112.

Similarly, embossed pattern 104D of inner layer 106 is substantially similar to and/or corresponds to embossed pattern 104B formed in second outer layer 112. More specifically, 3D embossed pattern 104D includes bumps 120D formed therein and/or thereon, and depressions 122D separating each bump 120D. As shown in FIG. 3, each bump 120D included in embossed pattern 104D is substantially aligned with a corresponding bump 120B of 3D embossed pattern 104B formed in second outer layer 112. Additionally in the non-limiting example, each bump 120D included in embossed pattern 104D is substantially aligned with a corresponding bump 120A of 3D embossed pattern 104A formed in first outer layer 108, and/or corresponding bump 120C of 3D embossed pattern 104C formed in inner layer 106.

FIG. 4 shows another cross-sectional front view of a non-limiting example of wipe 100 taken along line CS-CS in FIG. 1. In the non-limiting example, 3D embossed patterns 104A, 104B are distinct from one another. That is, 3D embossed pattern 104A formed and/or included within first outer layer 108 is distinct from 3D embossed pattern 104B formed and/or included within second outer layer 112. As shown in FIG. 4, and as similarly discussed herein, bumps 120A and depressions 122A of 3D embossed pattern 104A extend in a length-wise direction of wipe 100 (e.g., in-and-out of page in FIG. 4). Conversely, bumps 120B and depressions 122B of 3D embossed pattern 104B formed in second outer layer 112 extend in a width-wise direction of wipe 100 (e.g., left-to-right on page in FIG. 4). As such, and in the non-limiting example, 3D embossed pattern 104A of first outer layer 108 includes features (e.g., bumps 120A) that extend along wipe 100 in a direction substantially perpendicular to features (e.g., bumps 120B) of 3D embossed pattern 104B of second outer layer 112. That is, the opposing outer layers 108, 112, and opposing outer surface 110, 118, of wipe 100 formed from nonwoven fabric 102 include distinct 3D embossed patterns 104A, 104B when compared to one another.

FIG. 5 is another cross-sectional front view of a non-limiting example of wipe 100. In the non-limiting example, and as similarly discussed herein with respect to FIG. 3, 3D embossed pattern 104 extends into and/or are formed within inner layer 106. More specifically, 3D embossed pattern 104 includes 3D embossed pattern 104A formed in first outer layer 108, 3D embossed pattern 104B formed in second outer layer 112, and 3D embossed patterns 104C, 104D formed in inner layer 106. Distinct from bumps 120 of 3D embossed patterns 104 discussed herein with respect to FIGS. 1-4, bumps 120 shown in FIG. 5 include a distinct shape, geometry, and/or configuration. That is, and compared to bumps 120A, 120B shown and discussed herein with respect to FIG. 2, bumps 120A-120B included in 3D embossed patterns 104A-104D shown in FIG. 5 include substantially rectangular and/or angled configurations, as opposed to substantially curved geometries. As discussed herein, the embossing, imprinting, and/or calendaring processes used to form nonwoven fabric 102 determine and/or define the shape or configuration of bumps 120A-120D included in 3D embossed patterns 104A-104D for wipe 100.

As a result of processes forming 3D embossed patterns 104A-104D within nonwoven fabric 102, embossed pattern 104C of inner layer 106 is substantially similar to and/or corresponds to embossed pattern 104A formed in first outer layer 108. More specifically, 3D embossed pattern 104C includes bumps 120C formed therein and/or thereon, and depressions 122C separating each bump 120C. In the non-limiting example shown in FIG. 5, each bump 120C included in embossed pattern 104C is substantially aligned with a corresponding bump 120A of 3D embossed pattern 104A formed in first outer layer 108.

Similarly, embossed pattern 104D of inner layer 106 is substantially similar to and/or corresponds to embossed pattern 104B formed in second outer layer 112. More specifically, 3D embossed pattern 104D includes bumps 120D formed therein and/or thereon, and depressions 122D separating each bump 120D. As shown in FIG. 5, each bump 120D included in embossed pattern 104D is substantially aligned with a corresponding bump 120B of 3D embossed pattern 104B formed in second outer layer 112.

However, and based on the width-wise staggering of bumps 120A-120D included in 3D embossed patterns 104A-140D, each bump 120D included in embossed pattern 104D is substantially offset with a corresponding bump 120A of 3D embossed pattern 104A formed in first outer layer 108, as well as a corresponding bump 120C of 3D embossed pattern 104C formed in inner layer 106. Additionally, each bump 120C included in embossed pattern 104C formed in inner layer 106 is substantially offset with a corresponding bump 120B of 3D embossed pattern 104B formed in second outer layer 112, as well as a corresponding bump 120D of 3D embossed pattern 104D formed in inner layer 106. The staggering of features, and more specifically bumps 120A-120D and depressions 122A-122B within nonwoven fabric 102 allows for the overall thickness of wipe 100 to be substantially uniform, while still maintaining an increased surface area as a result of including embossed patterns 104A-104D within wipe 100.

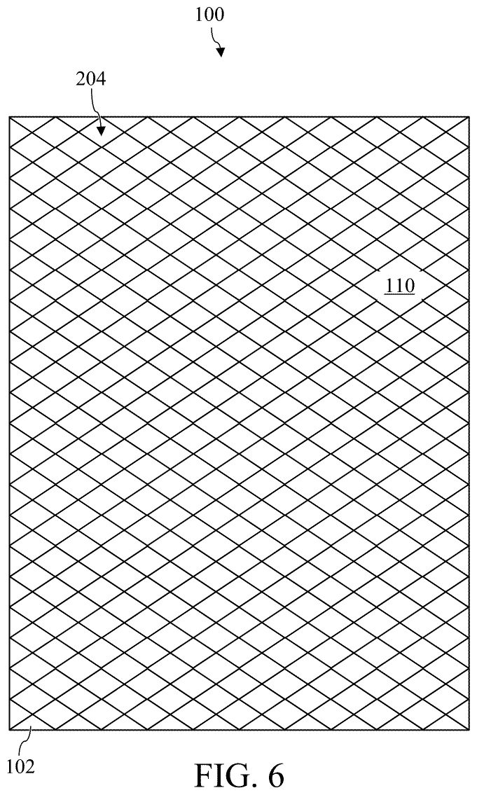

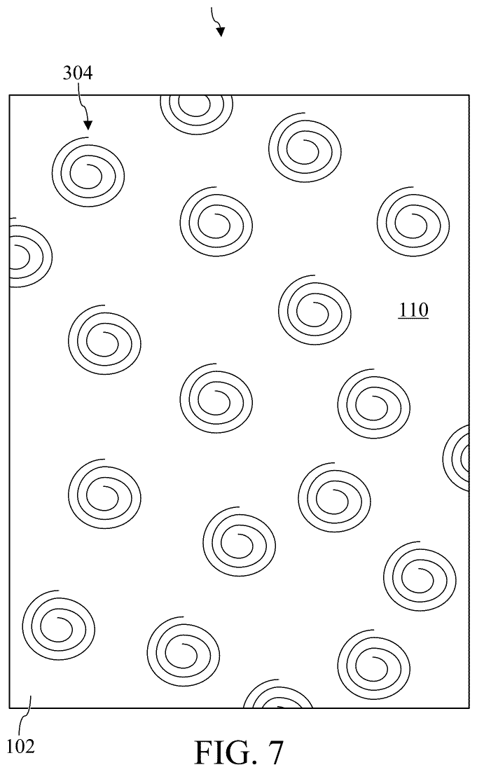

FIGS. 6 and 7 show top views of wipe 100 formed from laminated, nonwoven fabric 102. Specifically, FIGS. 6 and 7 depict non-limiting examples of wipe 100 including non-linear 3D embossed patterns 204, 304 included therein and/or thereon. For example, 3D embossed pattern 204 included on wipe 100, as shown in FIG. 5, includes a substantially quilted pattern, where features (e.g., bumps, depressions) extend diagonally between adjacent sides of wipe 100. As such, a diamond or quilted pattern is formed in nonwoven fabric 102 forming wipe 100. Alternatively, and as shown in FIG. 6, 3D embossed pattern 304 included in and/or on wipe 100 includes a plurality of random shapes, graphics, and/or visuals. For example, 3D embossed pattern 304 includes a plurality of spiral or swirl circles formed and/or dispersed through nonwoven fabric 102.

Regardless of the geometry or configuration of 3D embossed pattern, and the features included therein nonwoven fabric 102 forming wipe 100 includes a predetermined amount and/or number of embossing impressions within the fabric based on size. For example, 3D embossed pattern 204, 304 of nonwoven fabric 102 shown in FIGS. 6 and 7 include between approximately fifteen (15) impressions per square inch (in.²) and approximately twenty-five (25) impressions/in.².

At least one technical effect is to provide a laminated, nonwoven fabric that includes a desired tactile feel or weight, as well as increased strength, elongation, absorbency, titration percentages, and particle pick-up capabilities, while also reducing the amount of material used to form such nonwoven fabrics. To achieve the desired results, the laminated, nonwoven fabric includes 3D embossed patterns included therein and/or thereon. Additionally, the laminated, nonwoven fabric includes a three-layer construction including a meltblown-spunbond-meltblown (MSM) configuration, where the meltblown material (e.g., polypropylene (PP)) forms two opposing outer layers and the spunbond material (e.g., polypropylene (PP)) forms an inner layer, positioned between the two opposing outer layers.

### ADDITIONAL INFORMATION

The present application describes a sanitizer compatible food service wiper for useable with spray and wipe, closed bucket (pre-saturated wipe in a sealed container), and open bucket applications for Food Service. The wiper is manufactured from polypropylene (PP), not conventional materials such as, Polyester (PET) Fibers, Viscose, and Binders/Chemicals as is used in current solutions.

In an example, the polypropylene (PP) 3D embossed wiper is 100% recyclable; unlike conventional PET wipers currently being used. The 3D embossed pattern and configuration makes the wiper up to 2 times thicker, but the wiper weighs half as much as the conventional PET wiper.

The benefits and advantages of the polypropylene (PP) 3D embossed wiper is highly impactful because of the cost associated with the material and manufacturing process. For example, the wiper of the present disclosure can perform the same job, and be sanitizer compatible, for up to 30% less cost. Additionally, the polypropylene (PP) wiper has a one of kind 3D imprint that is embossed onto the substrate, which doubles the thickness of the wiper, makes it softer, enhances its ability to pick-up particulates from hard services (e.g., up to 40% more than standard PET Wiper), and improves both surface tension for picking up liquids and the application of sanitizers resulting in improved titration results.

Key attributes and characteristics for a 34 GSM wiper (e.g., wiper 100), made from 100% polypropylene (PP) include: a minimum machine direction (MD) tensile strength of approximately 40 gf/in/GSM, a minimum cross-machine direction (CD) tensile strength of approximately 15 gf/in/GSM, a minimum machine direction (MD) elongation of approximately 20%, a minimum cross-machine direction (CD) elongation of approximately 40%, an absorbency rate at a minimum of approximately 500%, a maximum thickness of approximately 15 mils, titration results equal to or greater than approximately 80%, a minimum improvement of particulate pick-up percentage compared to conventional wipers of approximately 3000%, and a minimum embossing density approximately 20 impressions per square inch.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately,” “about,” and/or “substantially” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A laminated, nonwoven fabric, comprising:
an inner layer formed from a spunbond material;
a first outer layer disposed over the inner layer, the first outer layer is formed from a meltblown material; and
a second outer layer disposed over the inner layer, opposite the first outer layer,
wherein at least one of the first outer layer or the second outer layer include a three-dimensional (3D) embossed pattern.

2. The laminated, nonwoven fabric of claim 1, wherein the spunbond material forming the inner layer is formed as polypropylene.

3. The laminated, nonwoven fabric of claim 2, wherein the meltblown material forming the first outer layer is formed as polypropylene.

4. The laminated, nonwoven fabric of claim 2, wherein the second outer layer is formed from the meltblown material.

5. The laminated, nonwoven fabric of claim 4, wherein the meltblown material forming the first outer layer and the second outer layer is non-polar.

6. The laminated, nonwoven fabric of claim 1, wherein the first outer layer includes a first outer surface, the first outer surface formed opposite the second outer layer and including the 3D embossed pattern.

7. The laminated, nonwoven fabric of claim 6, wherein the second outer layer includes a second outer surface, the second outer surface formed opposite the first outer surface of the first outer layer, wherein the second outer surface includes one of the 3D embossed pattern, or a distinct 3D embossed pattern.

8. A food service wipe, comprising:
a laminated, nonwoven fabric including:
an inner layer formed from a spunbond material;
a first outer layer disposed over the inner layer, the first outer layer is formed from a meltblown material; and
a second outer layer disposed over the inner layer, opposite the first outer layer,
wherein the laminated, nonwoven fabric includes a three-dimensional (3D) embossed pattern.

9. The wipe of claim 8, wherein the spunbond material forming the inner layer of the laminated, nonwoven fabric is formed as polypropylene.

10. The wipe of claim 9, wherein the meltblown material forming the first outer layer of the laminated, nonwoven fabric is formed as polypropylene.

11. The wipe of claim 9, wherein the second outer layer of the laminated, nonwoven fabric is formed from the meltblown material.

12. The wipe of claim 8, wherein the first outer layer of the laminated, nonwoven fabric includes a first outer surface, the first outer surface formed opposite the second outer layer and including the 3D embossed pattern.

13. The wipe of claim 12, wherein the second outer layer includes a second outer surface, the second outer surface formed opposite the first outer surface of the first outer layer, wherein the second outer surface includes one of the 3D embossed pattern, or a distinct 3D embossed pattern.

14. The wipe of claim 8, wherein the laminated, nonwoven fabric includes:
a machine direction (MD) tensile strength between approximately 30 grams force per inch per grams per square meter (gf/in/GSM) and approximately 80 gf/in/GSM, and
a cross-machine direction (CD) tensile strength between approximately 10 GSM and approximately 40 gf/in/GSM.

15. The wipe of claim 8, wherein the laminated, nonwoven fabric includes:
a machine direction (MD) elongation between approximately 15% and approximately 30%, and
a cross-machine direction (CD) elongation between approximately 30% and approximately 60%.

16. The wipe of claim 8, wherein the laminated, nonwoven fabric includes a titration result equal to or greater than approximately 80%.

17. The wipe of claim 8, wherein the laminated, nonwoven fabric includes a fabric weight between approximately 30 GSM and approximately 60 GSM.

18. The wipe of claim 8, wherein the laminated, nonwoven fabric includes a thickness between approximately 15 mils and approximately 45 mils.

19. The wipe of claim 8, wherein the 3D embossed pattern of the laminated, nonwoven fabric includes between approximately fifteen (15) impressions per square inch and twenty-five (25) impressions per square inch.

20. A wiper, comprising:
a polypropylene material; and
a three-dimensional (3D) pattern embossed on a surface of the polypropylene material.

21. The wiper of claim 20, wherein the polypropylene material includes:
an inner layer formed from a spunbond polypropylene material;
a first outer layer disposed over the inner layer, the first outer layer is formed from a meltblown polypropylene material; and
a second outer layer disposed over the inner layer, opposite the first outer layer, the second outer layer formed from a meltblown polypropylene material.

22. The wiper of claim 21, wherein the 3D embossed pattern is embossed on at least one of:
a first outer surface of the first outer layer, the first outer surface formed opposite the second outer layer, or
a second outer surface of the second outer layer, the second outer layer formed opposite the first outer surface of the first outer layer.

23. The wiper of claim 20, wherein the polypropylene material is non-polar.
